(19) United States
(12) Patent Application Publication
(10) Pub. No.: US 2004/0010508 A1
(43) Pub. Date: Jan. 15, 2004

(54) Method for selecting articles for viewing on continuous web page

(76) Inventors: Marcus Fest, Miami Beach, FL (US); Alberto Ibarguen, Miami, FL (US)

Correspondence Address: Marcus Fest, 935 - 4th Street, Miami Beach, FL, 33139, US

(21) Appl. No.: 10/215,321

(22) Filed: Aug. 8, 2002

Related U.S. Application Data
(60) Provisional application No. 60/394,679, filed on Jul. 9, 2002.

(51) Int. Cl. G06F 17/00

(52) U.S. Cl. 707/102

(57) ABSTRACT

Various methods are disclosed for enabling users of a computer system to specify a subset of news articles from a totality of available news articles via a one-page interface (“the Interface”) and display said subset of news articles by concatenating them inside a “personalized news page”. In one embodiment the invention is implemented as a Web-based multi-user system, with the Interface made up of three modules: A) News sections (“Business”, “Politics”, etc), B) News subjects (“Enron”, “Afghanistan”, etc) and C) a list of headlines of the totality of news stories available to the user at that moment, grouped into news categories. Each headline comes with a synopsis

### FIELD OF THE INVENTION

The present invention relates to methods for presenting information on Web pages to online users. More specifically, the invention relates to methods of presenting news articles.

### BACKGROUND OF THE INVENTION

Public networks, especially the World Wide Web as one part of the Internet, have emerged as an important conduit for news distribution. The Internet is a network of computers using an agreed-upon set of conventions to communicate with one another. The Web constitutes part of the Internet and comprises millions of “Web pages” interlinked through so-called “links” that enable users to easily navigate or “browse” between them. A Web browser is a client application that executes on a user's computer to display information contained on the Web pages on remote or local servers, including text, sound images, video and other data types.

The emergence of online news outlets has created the challenge of presenting news information in a format that makes best use of the unique properties of the Web and that enables readers to browse, retrieve and read news items in the most efficient manner.

The present invention describes a new and more efficient user interface for presenting online news.

Current online news sites typically present news content in the form of headlines that link to a page that displays the full article text. Sometimes the headlines are complemented by a few lines of additional text (“synopsis”) that is a summary of the associated news article or represents the first N sentences of the full text of said news article.

The headlines are usually grouped into topical categories according to news sections (“Business”, “Politics”, etc). Usually, a front page presents a plurality of the most important headlines from the different news sections, with additional links pointing to separate pages for each news category where the totality of headlines in that particular category is presented.

In order to read a plurality of news stories, a user browses the front page and/or news category pages and clicks on the headline links of news articles of interest. Clicking on a headline link replaces the front page or category page with the page that displays the full text of the associated article. The process of browsing headlines is thus interrupted until the news article is read and until the user clicks the browser's back key to return to the front page or category page that contained the article headline that user clicked on in order to display the news article he or she just completed reading. Sophisticated users can avoid this back-and-forth pattern by using a browser feature that enables them to open a link in a separate, additional browser window instead of inside the current window, thus avoiding the replacement of the front page or category page. Using this feature, the user can continue browsing headlines while pages with selected news articles open in additional browser windows. However, avoiding the need to navigate back and forth is traded for the new inconvenience of having to navigate between a plurality of separate browser windows.

Either method thus presents navigational inefficiencies, namely of having to navigate a plurality of Web pages and/or browser windows in order to select and read a plurality of news articles. Navigating a plurality of Web pages is time-consuming and involves the repetitive and inefficient back-and-forth process (“inefficient process”) described above. Navigating a plurality of browser windows is also time-consuming and usually exceeds the ability of the average online user. These problems of efficiency grow with the number of news articles a user wants to browse or read on a site during a given session. The online equivalent of reading a day's newspaper edition, i.e. browsing through the complete set of available articles on a news organization's Web site and reading a significant number of news articles entails a highly repetitive and therefore frustrating number of inefficient navigational steps.

Customization features available on existing news sites do little to alleviate this problem. For instance, personalized Web portals like myYahoo.com and many other news-oriented sites enable users to specify news categories by subject so that respective news article headlines are added to a users personalized “welcome page”. However, navigating between these headlines and the respective Web pages containing the articles' texts still involves the inefficient processes described above.

Some newspapers, for instance the Christian Science Monitor, resort to offering a page containing a complete list of all the day's articles' headlines. The headlines are linked to the respective news articles. Combining all the headlines inside a single page speeds up the process of browsing the entirety of available news headlines. However, navigating between the headlines and the associated articles again involves the inefficient process described above.

Accordingly, there remains a need to develop a significantly improved user interface for facilitating the user-controlled selection and display of Web-based news articles, especially if the goal is to browse the entirety of the news articles available.

### SUMMARY OF THE INVENTION

This invention concerns a Web-based graphical user interface that significantly improves a user's ability to define a subset of news articles out of a totality of the news articles available. The user defines the subset by selecting article headlines, subjects and/or news sections (“selectable items”) from the Interface. The Interface is coupled with a method of presenting the news articles thus defined by displaying them concatenated inside a single Web page.

The article headlines, subjects and sections (“selectable items”) are made selectable by a check box situated next to each item. The system translates the plurality of check marks placed by the user into a discrete subset of articles to be displayed. The system considers an article selected if any of the following the criteria are met: a) the article's corresponding headline in the Interface has been selected by the user; b) the user selected a subject item (“Afghanistan”, “Enron”, etc) whose definition is met by the article's content; c) the user selected a news section item (“Business”, “Politics”, etc) and the article belongs to the corresponding news section (for instance, because it is a business section article and the user has selected the “Business” news section item on the Interface) according to the news section property associated with the article when said article was entered into the system by the Web site operator.

For instance, if a user selected the “Business” news section check box, plus the “Afghanistan” subject check box plus the check boxes of headlines A, B, C, and D on the Interface, the system would consider as defined the following: all business section articles, all articles relating to the subject Afghanistan and the four articles referenced by the headlines A, B, C and D. The system will then display the defined articles by concatenating their full texts inside a single page, in effect generating a user's “personalized newspaper”.

According to an aspect of this invention, a multi-user system allows to retain individual users' different subject and section preferences. For instance, if a user during the most recent session selected “Business” and “Afghanistan”, the system will automatically set these items as selected at the user's next session, saving the user the need to reselect the items. The usefulness of this memory feature is based on the assumption that users will typically want to read articles from particular sections or about particular subjects on a continuous basis.

According to another aspect, a user may also choose to add freely definable subject selectors. For instance, if the user is interested in articles about “fly fishing”, the user may create the subject selector “fly fishing”. defining that the system is to consider any article containing the expression “fly fishing” to be associated with the newly created “fly fishing ” subject selector. Checking the fly fishing subject item will prompt the system to include all articles containing the expression “fly fishing” inside the users personalized news page. In accordance with the memory feature within a multi-user system described above, selecting the fly fishing subject in one session will automatically select it for the user for all following sessions, so that articles about fly fishing will be selected by default.

Similar to a user's adding a subject selector to the Interface, the Web site operator can add new subject selectors to (or delete existing selectors from) the Interface, affecting the Interface as it is seen by all users. For instance, if there is a new and on-going news development around the subject of “gene therapy”, the Web site operator can add a subject selector titled “gene therapy” to the subject module seen by all users. In order to add the new subject, the site operator has to specify which articles are to be associated with the new selector by specifying the appropriate keyword rules. For instance, the keyword rules may state that any article is to be considered to be associated with the “gene therapy” subject if the expressions “gene therapy” or “genome therapy” or “therapeutic cloning” are contained anywhere inside the article text.

According to another aspect of the invention, within the multi-user system implementation of the system, a user may also define which news section categories to include or omit in the headline sections of the Interface. For instance, the user may choose to permanently omit all sports or all business articles from the Interface.

According to another aspect of the invention a user may also customize the size of the synopsis that comes with each headline inside the Interface by specifying a number N, representing how many sentences of the full article's text are to be used as a synopsis.

### BRIEF DESCRIPTION OF THE DRAWINGS

The same reference numbers are used throughout the drawing to reference like components and features

FIG. 1 is a diagrammatic illustration of a client-server system

FIG. 2 is a diagrammatic illustration of the Interface disclosed in present invention

FIG. 3 is a block diagram illustrating a totality of news articles, a subset thereof, and a concatenation of article texts contained in said subset and the display of said concatenation inside a single display unit.

FIG. 4 is a flow diagram showing the process of using the interface disclosed in present invention within a multi-user system.

FIG. 5 is a flow diagram illustrating the process of defining a subset of news articles out of a totality of news articles based on criteria derived from user-controlled input via the Interface disclosed in present invention

### DETAILED DESCRIPTION

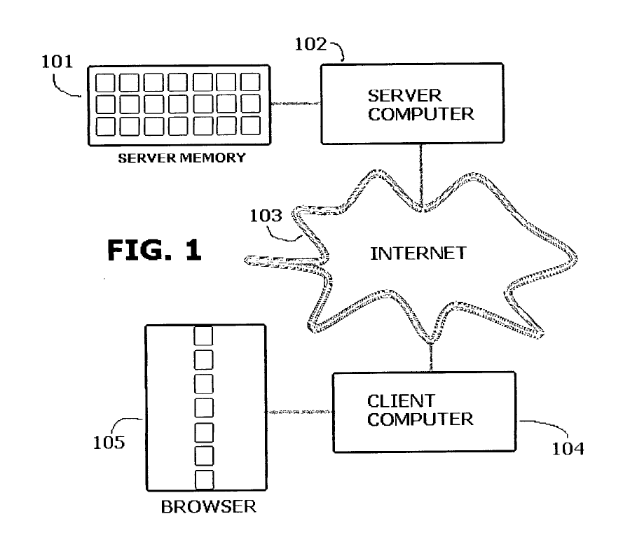

FIG. 1 shows a system comprising a client computer (104) running a browser program (105) and a server computer (102) with an associated data storage unit (101) containing in its storage a plurality of N news articles. Server and client computer are connected via the Internet (103), using the standard Internet Transmission Protocol (TCP/IP). This setup represents the standard situation of making server-based content available to Web users connecting to said server through the Internet using a browsing program running on a client computer.

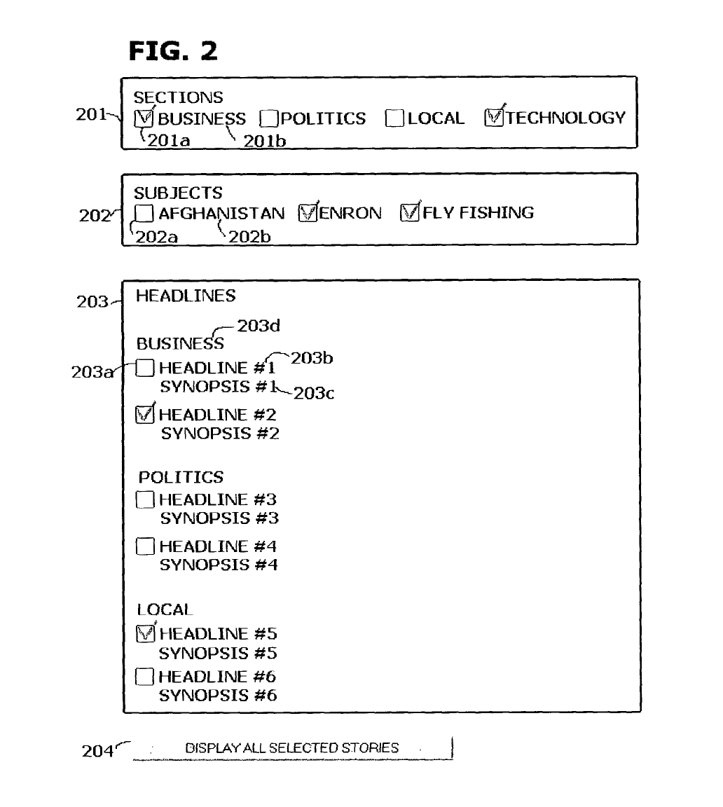

FIG. 2 illustrates the components of the Interface disclosed in present invention. The Interface is transmitted from the server computer to the display on the user's client computer using an Internet connection. The Interface consists of three selection modules (201, 202, 203), plus a submit component (204) (typically but not necessarily a button) that triggers the submission of the user-specified selections (ie. check marks placed into check boxes) from the client machine to the server machine when clicked by user.

The selection modules contain

news sections (201b) like “Business”, “Politics”, etc, selectable through a check box (201a) placed next to each item;

selectable news subjects (202b) like “Afghanistan”, “Enron”, “Fly Fishing”, etc;

and selectable news headlines (203b). Each headline comes with a synopsis (203c) that may comprise the first N lines of the article's text or be a summary of the article that is stored in the article database as one of various properties associated with the article. Other such properties associated with a news article may be “headline”, “full text”, “dateline”, “byline”, “photos to be displayed together with article”, “news category”, “page number” and similar properties typically associated with news articles. The headlines are grouped into news categories (203d)(“Business”, “Politics”, etc) that correspond with the news sections in the sections module (201).

A news organization would typically but not necessarily include the headlines of all the articles published on the current day, enabling a user to perform the online equivalent of browsing the entire content of a physical newspaper, i.e. quickly browse the entirety of current articles by scrolling down the Interface inside the browser window.

Each items inside each module (i.e. a section, subject or headline) has an interface component associated with it making it selectable. Typically but not necessarily this component is a check box(201a, 202a, 203a). By placing a check mark inside a check box through clicking on it, a user denotes the associated item (i.e. the section, subject or headline) as selected.

By selecting a plurality of sections, subjects and headlines from the Interface the user defines a subset of news articles. Clicking the Interface component for submitting the selections 204 will cause the server to receive the selection data, compute the subset of articles defined by it and then send to the client computer a Web page displaying the full texts of all the articles concatenate inside said Web page.

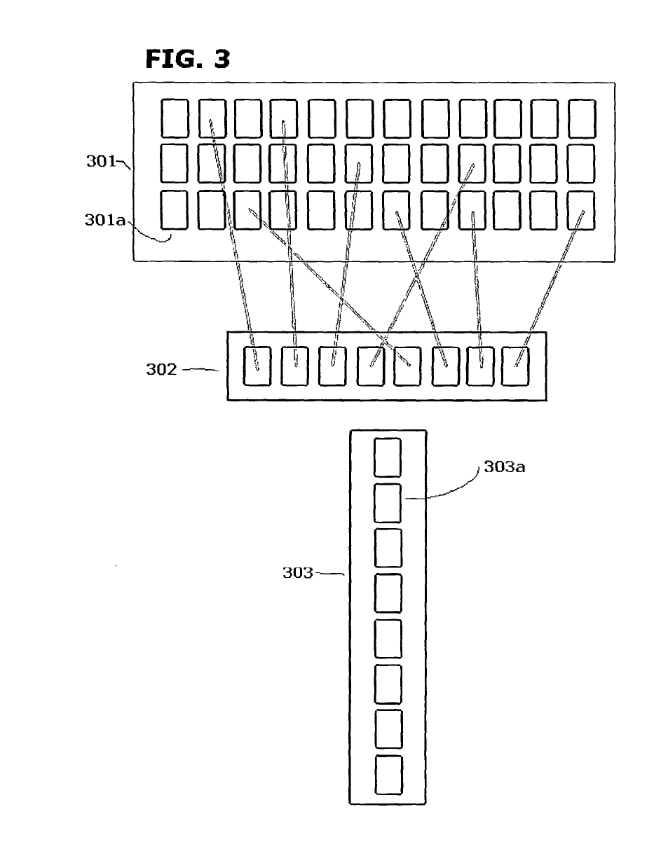

FIG. 3 illustrates a totality of N news articles (301) stored on the server, a subset thereof (302) and the concatenation of said subset inside a single Web page (303). By selecting sections (201), subjects (202) and headlines (203) in the Interface of FIG. 2. the user defines the criteria used by the server computer to create the subset (302).

Displaying the subset of news articles concatenated into a single Web page has the significant benefit of enabling the user to read all articles by scrolling down a single Web page.

Likewise, presenting selectable sections, subjects and headlines inside single Interface (FIG. 2) has the significant benefit of enabling a user to quickly and efficiently browse the headlines of the totality of available news stories and define a subset thereof.

In combination, these two features enable a user to efficiently perform the online equivalent of reading a daily newspaper.

Both, the containment of the selectable sections, subjects and headlines inside a single page and the display of the defined subset of news articles concatenated inside a single page solve the efficiency problem of “back-and-forth” navigation that result when trying to browse the totality of news available on traditional news-oriented Web sites.

Essentially, the Interface presents the most efficient possible solution to users who come to a news-oriented Web site with the goal of browsing the entirety of news articles available and reading a subset thereof based on their individual news preferences.

Multi-User System

An aspect of the invention involves making the Interface available within a Web-based multi-user system.

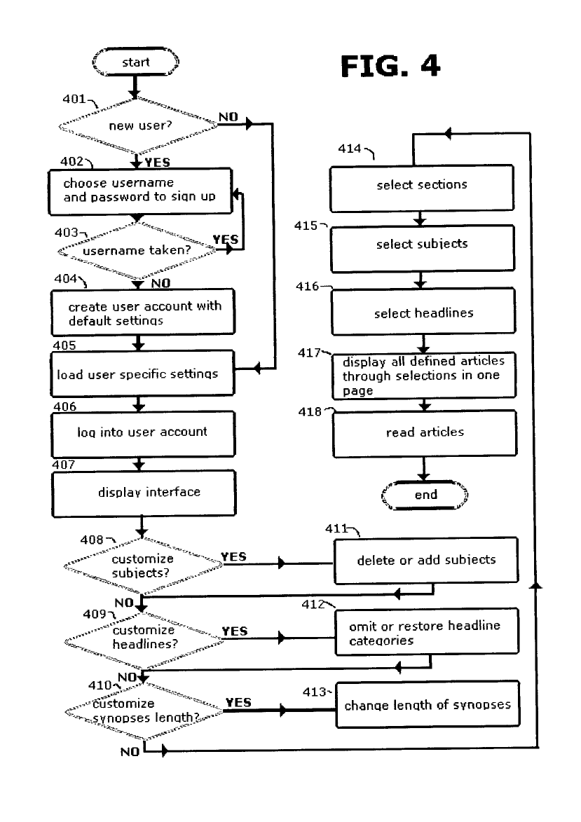

FIG. 4 shows a flow chart illustrating the process of a user interacting with said multi-user system, representing a typical user session. In step 401, a user indicates whether he (“he”, for practical purposes in this document, shall stand for “he or she”) has signed up for a user account in the past or whether he uses the system for the first time. In case of a first time user, step 402 prompts the user to create an account by choosing a username and password. If the username (or username/password combination) chosen by the user does not yet exist (step 403), the system creates the user account with the default settings (step 404), loads the default settings (405), logs the user in (406), and displays the Interface (407). Customization settings comprise:

subject selectors,

the categories (“Business”, “Sports”) included inside the headline section,

the order of said categories,

and the number of lines for the synopsis that comes with each headline.

Existing users start by entering their username and password upon whose correct submission the system will load the user's customization settings (405).

Step 405 loads the following customizable, user-specific settings:

Information about which sections and subjects the user selected during the most recent session

and preselecting those sections and subjects automatically (ie. putting check marks in the respective section and subject check boxes) for the current session.

The number N determining the length of the synopsis that comes with each artice headline. In one embodiment this synopsis is generated displaying the first N sentences of the full article's text, with the number N customizable by each user.

Another user-controllable customization setting loaded in step XX consists of information indicating which news categories to include inside the headline section of the Interface and in what order to present these category groupings.

In steps 408, 409 and 410 the user may change any of the above mentioned customization settings.

In step 408 the user may add new subject selectors or delete existing ones (411). Adding a new subject selector involves naming it and entering a keyword rule for it. A keyword rule is a Boolean expression (using keywords and logical operators like “AND”, “OR” and “NOT”) telling the system which keywords have to be present (and/or not present) in the full text of an article in order to consider said article selected if said new subject selector is selected.

In step 409 the user may delete news categories groups from the headline section or change the order of those groups (for instance, making sports headlines come first and business headlines come last, step 412). In step 410 the user may change the number N determining the size of the synopsis displayed with each headline.

In this embodiment, these user-specific settings are stored in memory on the server. However, they could also be stored in so-called “cookie files” on the user's client computer. The latter variant would have the disadvantage, however, that a user would lose his settings when accessing the Interface from a different computer or if the cookie information on his computer should be lost or destroyed.

In steps 414, 415 and 416 the user then proceeds to choose sections, subjects and headlines from the Interface, then clicks the submit button which prompts the system to display the defined subset of articles concatenated inside a single page (step 417). Step 418 consists of the user viewing the “personalized newspage”.

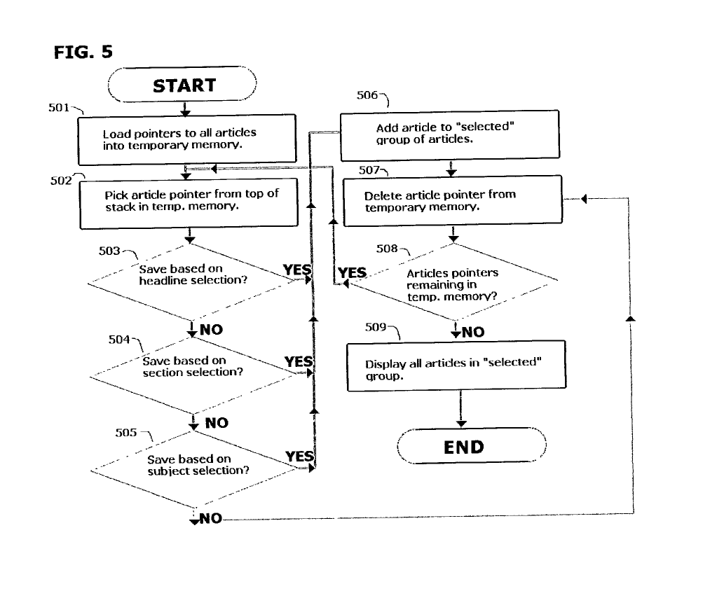

FIG. 5 illustrates the process by which a program on the server interprets the plurality of section, subject and headline selections submitted by the user in order to create a subset of news articles from the totality of available news articles.

In order to create the subset, the system performs a loop in which it checks each available article against three criteria established by the selections the user has submitted to the server. If any one of the criteria is met, the article is added to the subset. In step 501 pointers to all available articles are loaded into a memory stack. In step 502 the article on top of the step is picked for examination against three criteria (steps 503,504,505)

The first criterion is whether the article belongs to any one of the sections (“Business”, “Politics”, etc) selected by the user (504). Association with one and only one section is a news article property specified by the Web site operator at the time a news article is entered into the system. I.e., when adding a news article, an editor has to tell the system whether the article belongs to the “Business” section, or the “Politics” section etc.

The second criterion is whether an article falls under any of the subjects selected by the user (505). Each available subject (“Afghanistan”, “Fly Fishing”, etc) equates a Boolean expression of keywords that the system applied to the text contained inside the news articles. An example for a Boolean expression is <<IF ARTICLE TEXT CONTAINS THE PHRASE “FLY FISHING”>>. If the expression is true as applied to an article text, said article is added to the subset of news articles. If not, said article is not added.

The third criterion is whether the headline associated with the article has been selected by the user (503). If selected, the article is added to the subset. If not selected, the article is not added.

After having examined an article against these three criteria it is either added to the “selected” group of articles (506) or not. In either case it is deleted from the temporary memory stack containing all articles. The system continues the loop picking the next article from top of the stack (502).

After the system has determined that it has looped through each available article and checked it against the three criteria (508), the subset definition is complete. In step 509 the system then displays the articles contained in said subset concatenated inside a single browser window (or other display unit). This loop process just represents one of any possible algorythms that would achieve the same goal. For instance, another more efficient process may entail not checking the full text of each article against the rules for each subject selector but instead checking the rules against an index of words found in all articles.

Although the invention has been described in terms specific to certain features and/or logical steps, it is to be understood that the invention defined in the appended claims is not necessarily limited to the specific features and claims described. Rather, the specific features and steps are disclosed as preferred forms of implementing the claimed invention.

1. A method for providing a single page compilation of a plurality of user-selected articles from a single information provider to a user across a global computer network comprising the steps of:
presenting a plurality of selectable items wherein each said selectable item is associated with one or more articles,
for each said selectable item, presenting an index of the subject matter of each of said articles associated with said selectable item;
receiving a user's selection of items comprising a plurality articles for display;
retrieving each of said plurality of articles from a source;
combining each of said plurality of articles into a single file;
transmitting the contents of said single file to said user for viewing.

2. The method of claim 1 wherein said articles are gathered and maintained by a news organization and said source is a database containing said articles.

3. The method of claim 2 further comprising the step of registering said user with said news organization before said user will be permitted to access information from said news organization.

4. The method of claim 1 wherein said articles are combined within said single page in accordance with one or more predetermined criteria.

5. The method of claim 1 wherein said single file is a hypertext markup language file, said global computer network is the internet, and said file is downloaded for processing on a computer.

6. The method of claim 2 in which said plurality of selectable items comprises headlines generated by said news organization, sections established by said news organization, and subjects.

7. The method of claim 1 in which said user can create additional selectable items and article selection criteria, and indexes of articles maintained by said source and falling within said selection criteria are displayed to said user for selection.

8. The method of claim 1 further comprising recording prior selection criteria made by said user and presenting to said user articles meeting said recorded selection criteria previously established by said user.
